(19) United States
(12) Patent Application Publication
(10) Pub. No.: US 2026/0267199 A1
(43) Pub. Date: Sep. 10, 2026

(54) OPTICAL PARAMETRIC AMPLIFIER

(71) Applicant: NTT, Inc., Tokyo (JP)

(72) Inventors: Takushi Kazama, Tokyo (JP); Takeshi Umeki, Tokyo (JP)

(21) Appl. No.: 18/876,528

(22) PCT Filed: Jun. 21, 2022
(86) PCT No.: PCT/JP2022/024665

§ 371 Date: Dec. 18, 2024

(51) Int. Cl. G02F 1/39; G02F 1/35; G02F 1/377

(52) U.S. Cl. CPC G02F 1/392; G02F 1/3507; G02F 1/3775; G02F 2202/20

(57) ABSTRACT

An optical parametric amplifier includes a waveguide that has two phase matching wavelengths λ1 and λ2 and performs parametric amplification of a signal light group 20, and an excitation light generator configured to generate excitation light to be input to the waveguide. The phase matching wavelengths λ1 and λ2 satisfy a relationship of λ1<λsi<λ2 with respect to a wavelength λsi (i=1, 2, 3, . . . ) of the signal light group. The excitation light generator is configured to generate excitation light having a wavelength in the vicinity of λ1/2 and excitation light having a wavelength in the vicinity of λ2/2 and input the generated rays of excitation light to the waveguide. The waveguide includes non-linear optical crystal having a periodic polarization inversion structure having two polarization inversion periods Λλ1 and Λλ2.

### CROSS-REFERENCE TO RELATED APPLICATIONS

This application is a national phase entry of PCT Application No. PCT/JP2022/024665, filed on Jun. 21, 2022, which application is hereby incorporated herein by reference.

### TECHNICAL FIELD

The present invention relates to an optical parametric amplifier used in an optical communication system or a laser device.

### BACKGROUND

In an optical communication system, an erbium-doped fiber amplifier (EDFA) is widely used to relay a signal attenuated due to propagation through an optical fiber. In the EDFA, excitation light is incident on an erbium-doped fiber (EDF) obtained by doping erbium, and the incident light is amplified by stimulated emission in the EDF.

Until the EDFA was put into practical use, a method of first converting the attenuated light into an electric signal, identifying a digital signal, and then converting the electric signal into an optical signal again was used. In order to perform such optical-electrical-optical conversion, many optical components and electrical components are required, and the relay cost of optical communication is increased.

However, the practical use of the EDFA has made it possible to amplify an optical signal as it is, and to collectively amplify signals of wavelength division multiplexing (WDM) in which separate information is carried on a plurality of wavelengths and transmitted. Therefore, the amplification and the relay of the optical signal can be performed with a simple configuration, and the cost of the optical relay can be significantly reduced. In particular, in an optical communication network in which an optical signal is transmitted over a long distance, the entire system is designed on the premise of using the EDFA.

With diversification of information communication technology services in recent years, an optical communication system that supports a backbone of a communication network requires a further increase in transmission capacity. According to Shannon's communication theory, the frequency utilization efficiency defined by the ratio of the transmission capacity per unit frequency band is log 2(1+S/N) with respect to the signal-to-noise (S/N) ratio. Therefore, the upper limit of the S/N ratio determines the theoretical upper limit of the transmission capacity. An S/N ratio in a receiver of optical communication is proportional to power of an optical signal under a condition that so-called shot noise is dominant. Thus, in order to increase the frequency utilization efficiency, it makes sense in principle to perform transmission with high optical power.

However, in reality, an optical fiber that is a transmission medium of optical communication has a non-linear optical effect. It is pointed out that, when the transmission power is increased more than necessary, the S/N ratio of an optical signal actually gets worse due to the influence of the non-linear optical effect. This degradation of the S/N ratio is called a non-linear Shannon limit, and is discussed as a phenomenon that may limit the upper limit of the transmission capacity of the optical communication system.

As described above, due to the non-linear Shannon limit, the theoretical upper limit of the frequency utilization efficiency in the optical communication system starts to appear. In order to further increase the communication capacity, it is essential to expand a frequency band used for optical communication.

However, in the optical communication system using the above-described EDFA, the following problems still exist. Wavelength bands that can be amplified by an EDFA widely used in the current optical communication systems are limited to a C band (1530 to 1565 nm) and an L band (1565 to 1625 nm). Therefore, the current optical communication systems are constructed on the premise of using these wavelength bands. Since the transparent wavelength band of the optical fiber itself is very broad, the transmission capacity of optical communication can be greatly expanded so long as a wavelength band other than the C and L bands can be used.

Since an optical amplifier such as an EDFA using a rare earth element for a laser medium uses a transition between energy levels of the rare earth element, there is a limit to options of a wavelength range that can be amplified. As a method of realizing optical amplification to which such a limitation is not applied, there is a method using parametric amplification using a secondary to tertiary non-linear optical medium. A typical example of the tertiary non-linear optical medium uses four-wave mixing in an optical fiber. However, the non-linear optical effect of the optical fiber may also cause degradation of the S/N ratio of the optical signal as described above. Therefore, the use of the tertiary non-linear optical medium has a problem as a low-noise optical amplifier.

On the other hand, a typical example of the secondary non-linear optical medium uses an optical waveguide made of periodically poled lithium niobate (PPLN). For example, Non Patent Literature 1 illustrates that a broadband optical amplification operation can be performed by using difference frequency generation that is a secondary non-linear optical effect by PPLN. In the method using PPLN, since the tertiary non-linear optical effect can be ignored, it may be considered that there is almost no deterioration in signal quality due to the non-linear optical effect.

FIG. 7 illustrates a basic configuration of an optical parametric amplifier and a wavelength converter using a secondary non-linear optical medium such as a PPLN waveguide, in the related art. Non Patent Literature 2 discloses this configuration. In the configuration in the related art, two secondary non-linear optical elements 100 and 101 having the same phase matching wavelength (1550 nm) are used. The secondary non-linear optical elements 100 and 101 include PPLN waveguides 1000 and 1010, respectively. A laser light source 102 used in optical communication generates fundamental wave light in a 1550 nm band. An EDFA 103 amplifies the fundamental wave light in order to obtain enough power to obtain a non-linear optical effect. The secondary non-linear optical element 100 is an element for second harmonic generation (SHG), and generates second harmonic light from the amplified fundamental wave light 200.

The secondary non-linear optical element 101 is an element for difference frequency generation (DFG), and performs non-degenerate parametric amplification of signal light 203 input from the outside by using second harmonic light 204 output from the secondary non-linear optical element 100 as excitation light. At the same time, wavelength conversion light (idler light) corresponding to a difference in frequency between the signal light and the excitation light is also generated by the DFG process. The configuration in FIG. 7 functions as an optical amplifier when only the amplified signal light is extracted from the output side of the secondary non-linear optical element 101, and functions as a wavelength converter when only the wavelength conversion light is extracted.

FIG. 8 is a diagram illustrating an optical parametric amplification process and a DFG band in the related art. Here, the description will be made by using the DFG process, but the principle is similar in the optical parametric amplification process. The reference sign 200 in (b) of FIG. 8 denotes single-wavelength fundamental wave light output from a single laser light source. In (a) of FIG. 8, the reference sign 201 denotes a phase matching curve with respect to the SHG of the PPLN waveguide, the reference sign 202 denotes a phase matching curve with respect to the DFG of the PPLN waveguide, the reference sign 203 denotes the signal light, and the reference sign 205 denotes conversion light. The phase matching band of the PPLN waveguide with respect to the SHG is narrower than the phase matching band with respect to the DFG, but is sufficiently broader than the line width of the fundamental wave light.

Here, the wavelength conversion band of the PPLN waveguide when the wavelength λ0 (frequency ω0) of the fundamental wave is set to 1545 nm and the wavelength λp (frequency 2ω0) of the excitation light is set to 772.5 nm will be described. By inputting the excitation light and the signal light to the PPLN waveguide, the conversion light is generated by the DFG process. For example, if the signal light wavelength λs (frequency ωs) is set to 1540 nm, conversion light having a wavelength of 1550 nm is generated by 2ω0−ωs. As illustrated in (a) of FIG. 8, the conversion light is generated in a form in which the signal light is folded back on the wavelength axis with the wavelength λ0 of the fundamental wave as the center.

In the PPLN waveguide, quasi-phase matching conditions are satisfied among three waves of excitation light, signal light, and conversion light. That is, when the effective refractive indices of the excitation light, the signal light, and the conversion light in the waveguide are set as np, ns, and nc, respectively, the PPLN waveguide has a polarization inversion structure with an inversion period Λ that satisfies Expression (1).

$$np / λ p - ns / λ s - nc / λ c = 1 / Λ \qquad ( 1 )$$

As long as Expression 1 is satisfied, even if the wavelength of the signal light is changed, the same conversion efficiency can be obtained between the conversion light having the frequency 2ω0−ωs and the excitation light. Specifically, if the wavelength λs (frequency ωs) of the signal light is set to 1539 nm, conversion light having a wavelength of 1551 nm is generated by 2ω0−ωs. Although the effective refractive index ns of the signal light and the effective refractive index nc of the conversion light also change at this time, Expression (1) can be satisfied even though the wavelength of the signal light is changed, because nc decreases as ns increases with the dispersion of the material. As a result, the parametric amplifier using the PPLN waveguide can obtain a broad wavelength conversion band as illustrated in (a) of FIG. 8.

Since the dispersion of the material is not linear, the amount of increase in the effective refractive index ns of the signal light and the amount of decrease in the effective refractive index nc of the conversion light are not completely equal to each other. In addition, the wavelength conversion band is limited as the conversion efficiency gradually decreases. However, in a case where the wavelength (in this example, 1545 nm) of the fundamental wave light is matched with the phase matching wavelength, when the PPLN waveguide length is set to 45 mm, a band of about 60 nm can be obtained with the wavelength of the fundamental wave light as the center, and amplification having a band broader than that of a general EDFA can be performed. Furthermore, as disclosed in Non Patent Literature 1, the amplification band shape can be changed by detuning the phase matching wavelength and the excitation light wavelength, and optical amplification in a broader band can be performed.

However, although broadband amplification can be expected in the optical parametric amplification using the PPLN waveguide, there is still the following problem.

As described above, in the parametric amplification process, not only is the signal light amplified, but also the conversion light is generated to have a wavelength obtained by folding the wavelength of the signal light with the wavelength of the fundamental wave light as the center. Therefore, when the signal light group incident on the PPLN waveguide is provided on both the long wavelength side and the short wavelength side with respect to the wavelength of the fundamental wave light, the conversion light with respect to the signal light on the long wavelength side is generated in the signal light wavelength band on the short wavelength side, and the conversion light with respect to the signal light on the short wavelength side is generated in the signal light wavelength band on the long wavelength side. Therefore, it is necessary to separate the signal light in advance.

Therefore, when the signal light is amplified in the entire parametric amplification band, the input signal light is separated into the short wavelength side and the long wavelength side by using a wavelength demultiplexer 300 as illustrated in FIG. 9. The reference sign 400 in FIG. 10A denotes signal light incident on the wavelength demultiplexer 300, the reference sign 401 in FIG. 10B denotes signal light on the short wavelength side, which has been separated by the wavelength demultiplexer 300, and the reference sign 402 in FIG. 10C denotes signal light on the long wavelength side, which has been separated by the wavelength demultiplexer 300.

Amplification and conversion light generation are performed by causing the signal light on the short wavelength side to pass through a secondary non-linear optical element 301, and causing the signal light on the long wavelength side to pass through a secondary non-linear optical element 302. The secondary non-linear optical elements 301 and 302 include PPLN waveguides 3010 and 3020, respectively. The reference sign 403 in FIG. 10D denotes conversion light generated by the secondary non-linear optical element 301, and the reference sign 404 in FIG. 10E denotes conversion light generated by the secondary non-linear optical element 302. When the output light of the secondary non-linear optical element 301 and the output light of the secondary non-linear optical element 302 are multiplexed, a wavelength multiplexer 303 cuts the conversion light output from the secondary non-linear optical element 301 and the conversion light output from the secondary non-linear optical element 302. In this manner, as illustrated in FIG. 10F, only the original signal light is multiplexed.

As described above, although the optical parametric amplifier using the PPLN waveguide can perform broadband amplification, the configuration illustrated in FIG. 9 is required when the entire amplification band is used.

The configuration of FIG. 9 has two problems. A first problem is that, because it is necessary to separately amplify the signal light on the long wavelength side and the signal light on the short wavelength side, two PPLN waveguides used for amplification are required, the number of components increases, and the configuration becomes complicated. A second problem is that the signal light needs to be separated by the wavelength demultiplexer before amplification, and thus the noise figure of the amplifier increases with the transmission loss of the wavelength demultiplexer. When the noise figure increases, it is not possible to transmit a signal far away while maintaining the quality of the signal no matter how broad the band is, and therefore, excessive noise of the amplifier must be suppressed as much as possible.

### CITATION LIST

### Non Patent Literature

Non Patent Literature 1: M. H. Chou, I. Brener, K. R. Parameswaran and M. M. Fejer, “Stability and bandwidth enhancement of difference frequency generation (DFG)-based wavelength conversion by pump detuning”, ELECTRONICS LETTERS, 10th June 1999, Vol. 35, No. 12, pp. 978-990
Non Patent Literature 2: T. Umeki, O. Tadanaga, A. Takada, and M. Asobe, “Phase sensitive degenerate parametric amplification using directly-bonded PPLN ridge waveguides”, Optics Express, Vol. 19, No. 7, pp. 6326-6332, 2011

### SUMMARY

### Technical Problem

Embodiments of the present invention has been made to solve the above problems, and an object thereof is to provide an optical parametric amplifier capable of broadband and low-noise optical amplification with a simple configuration.

### Solution to Problem

According to embodiments of the present invention, an optical parametric amplifier includes a first optical waveguide having two phase matching wavelengths λ1 and λ2 (λ1<λ2), the first optical waveguide configured to perform parametric amplification of a signal light group, and an excitation light generation unit configured to generate excitation light to be input to the first optical waveguide. The phase matching wavelengths λ1 and λ2 are set to satisfy a relationship of λ1<λsi<λ2 with respect to a wavelength λsi (i=1, 2, 3, . . . ) of the signal light group. The excitation light generation unit generates excitation light having one or a plurality of wavelengths in the vicinity of λ1/2 and excitation light having one or a plurality of wavelengths in the vicinity of λ2/2 and inputs the generated rays of excitation light to the first optical waveguide. The first optical waveguide is made of non-linear optical crystal having a periodic polarization inversion structure having two polarization inversion periods Λλ1 and Λλ2. When a refractive index of light having a wavelength λ1/2 in the first optical waveguide is represented by nλ1/2, a refractive index of light having a wavelength λ2/2 is represented by nλ2/2, a refractive index of light having a wavelength λ1 is represented by nλ1, and a refractive index of light having a wavelength λ2 is represented by nλ2, the polarization inversion periods Λλ1 and Λλ2 satisfy relationships of nλ1/2/(λ1/2)−2nλ1/λ1=1/Λλ1, and nλ2/2/(λ2/2)−2nλ2/λ2=1/Λλ2.

### Advantageous Effects

According to embodiments of the present invention, the optical parametric amplifier using the first optical waveguide having the two phase matching wavelengths λ1 and λ2 at both ends of a signal optical band is configured. Thus, the wavelength demultiplexer is not required as compared with the optical parametric amplifier in the related art. Therefore, it is possible to not only reduce the number of components, but also suppress an excessive loss. As a result, it is possible to perform amplification with a noise figure inherent in the optical parametric amplifier, and to perform broadband and low-noise optical amplification.

### BRIEF DESCRIPTION OF THE DRAWINGS

FIG. 1 is a block diagram illustrating a configuration of an optical parametric amplifier according to a first embodiment of the present invention.

FIG. 2 is a diagram for describing an operation of parametric amplification in a PPLN waveguide according to the first embodiment of the present invention.

FIG. 3 is a block diagram illustrating another configuration of the optical parametric amplifier according to the first embodiment of the present invention.

FIG. 4 is a block diagram illustrating still another configuration of the optical parametric amplifier according to the first embodiment of the present invention.

FIG. 5 is a block diagram illustrating a configuration of an optical parametric amplifier according to a second embodiment of the present invention.

FIG. 6 is a diagram illustrating an amplification band of the optical parametric amplifier according to the second embodiment of the present invention.

FIG. 7 is a block diagram illustrating a basic configuration of an optical parametric amplifier and a wavelength converter in the related art.

FIG. 8 is a diagram illustrating an optical parametric amplification process and a DFG band in the related art.

FIG. 9 is a block diagram illustrating another configuration of the optical parametric amplifier in the related art.

FIGS. 10A to 10F are diagrams illustrating spectra of signal light, conversion light, and amplified signal light in the optical parametric amplifier of FIG. 9.

### DETAILED DESCRIPTION OF ILLUSTRATIVE EMBODIMENTS

### First Embodiment

Hereinafter, embodiments of the present invention will be described with reference to the drawings. The present embodiment proposes a configuration in which, by using a secondary non-linear optical medium such as PPLN having two phase matching wavelengths λ1 and λ2 (λ1<λ2) and using two rays of second harmonic excitation light having the same wavelengths as the two phase matching wavelengths λ1 and λ2, it is not necessary to demultiplex a signal light into two rays of light on a short wavelength side and a long wavelength side, and broadband optical amplification without excessive optical loss can be realized. A plurality of phase matching wavelengths can be realized, for example, by providing a plurality of periodic structures in multiple stages in a periodic polarization inversion structure in a PPLN waveguide. In addition, a chirp-type periodic structure that gradually changes the structure in an element from a period of a certain characteristic to another period may be provided. In addition, a multi-quasi-phase-matching (QPM) element that can be realized by applying long-period spatial periodic phase modulation to the basic periodic structure may be used.

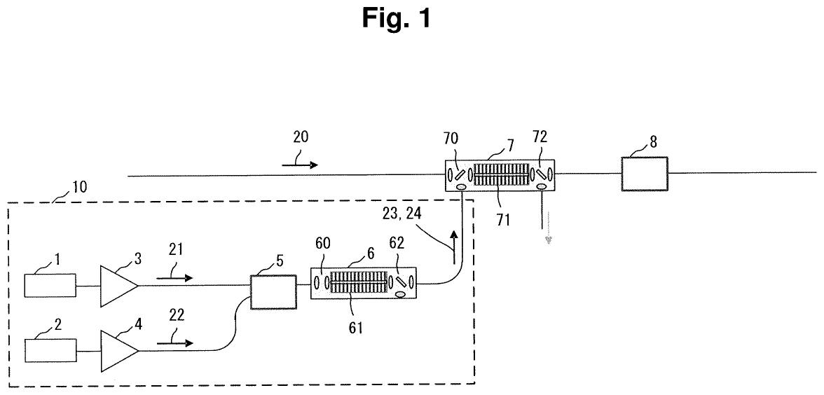

FIG. 1 is a block diagram illustrating a configuration of an optical parametric amplifier according to the present embodiment. The optical parametric amplifier includes a laser light source 1, a laser light source 2, EDFAs 3 and 4, a multiplexer 5, a secondary non-linear optical element 6, a secondary non-linear optical element 7, and a bandpass filter 8. The laser light source 1 generates fundamental wave light having a wavelength in the vicinity of the phase matching wavelength λ1. The laser light source 2 generates fundamental wave light having a wavelength in the vicinity of the phase matching wavelength λ2. The EDFAs 3 and 4 amplify the generated rays of fundamental wave light from the laser light sources 1 and 2. The multiplexer 5 multiplexes the fundamental wave light amplified by the EDFAs 3 and 4. The secondary non-linear optical element 6 includes a PPLN waveguide 61 (second optical waveguide) that has the phase matching wavelengths λ1 and λ2 and generates second harmonic light from output light of the multiplexer 5. The secondary non-linear optical element 7 includes a PPLN waveguide 71 (first optical waveguide) that has the phase matching wavelengths λ1 and λ2 and performs parametric amplification of a signal light group 20. The bandpass filter 8 causes the signal light group after the parametric amplification to pass therethrough, and a pass band is set to remove wavelength conversion light in the bandpass filter 8. The laser light sources 1 and 2, the EDFAs 3 and 4, the multiplexer 5, and the secondary non-linear optical element 6 constitute an excitation light generation unit 10.

The secondary non-linear optical element 6 includes a spatial optical system 60, the PPLN waveguide 61, and a spatial optical system 62. The secondary non-linear optical element 7 includes a spatial optical system 70, the PPLN waveguide 71, and a spatial optical system 72.

The spatial optical system 60 guides the light incident from the multiplexer 5 to the PPLN waveguide 61. The spatial optical system 62 guides the light emitted from the PPLN waveguide 61 to the output port of the secondary non-linear optical element 6. The spatial optical system 70 multiplexes the signal light group and the excitation light and guides the result of the multiplexing to the PPLN waveguide 71. The spatial optical system 72 guides the light emitted from the PPLN waveguide 71 to the output port of the secondary non-linear optical element 7.

In the present embodiment, the two PPLN waveguides 61 and 71 having two phase matching wavelengths λ1 and λ2 (λ1<λ2) are used. The phase matching wavelengths λ1 and λ2 satisfy a relationship of λ1<λsi<λ2 with respect to a wavelength λsi (i=1, 2, 3, . . . ) of the signal light group 20. That is, it is assumed that the phase matching wavelengths λ1 and λ2 are wavelengths at both ends of the band of the signal light.

The PPLN waveguide 61 is made of non-linear optical crystal (LiNbO3 in the present embodiment) having a periodic polarization inversion structure having two polarization inversion periods Λλ1 and Λλ2. The PPLN waveguide 71 also has the same structure as the PPLN waveguide 61. The polarization inversion periods Λλ1 and Λλ2 satisfy the following relationship.

$$n λ 1 / 2 / ( λ 1 / 2 ) - 2 n λ1 / λ1 = 1 / Λλ1 \qquad ( 2 )$$

$$n λ2 / 2 / ( λ2 / 2 ) - 2 n λ2 / λ2 = 1 / Λλ2 \qquad ( 3 )$$

nλ1/2 indicates a refractive index of light having a wavelength λ1/2 in the PPLN waveguides 61 and 71, nλ2/2 indicates a refractive index of light having a wavelength λ2/2 in the PPLN waveguides 61 and 71, nλ1 indicates a refractive index of light having a wavelength λ1 in the PPLN waveguides 61 and 71, and nλ2 indicates a refractive index of light having a wavelength λ2 in the PPLN waveguides 61 and 71.

The laser light sources 1 and 2 generate fundamental wave light having wavelengths λ1 and λ2, respectively. The EDFAs 3 and 4 amplify the fundamental wave light from the laser light sources 1 and 2 in order to obtain enough power to obtain a non-linear optical effect. The multiplexer 5 multiplexes rays of the fundamental wave light 21 and 22 amplified by the EDFAs 3 and 4.

The PPLN waveguide 61 having the phase matching wavelengths λ1 and λ2 generates second harmonic light from the rays of fundamental wave light 21 and 22, respectively. As a result, in the present embodiment, the rays of second harmonic light 23 and 24 having two wavelengths are generated.

The PPLN waveguide 71 having the phase matching wavelengths λ1 and λ2 performs parametric amplification of the signal light group 20 by using the rays of second harmonic light 23 and 24 output from the PPLN waveguide 61 as excitation light.

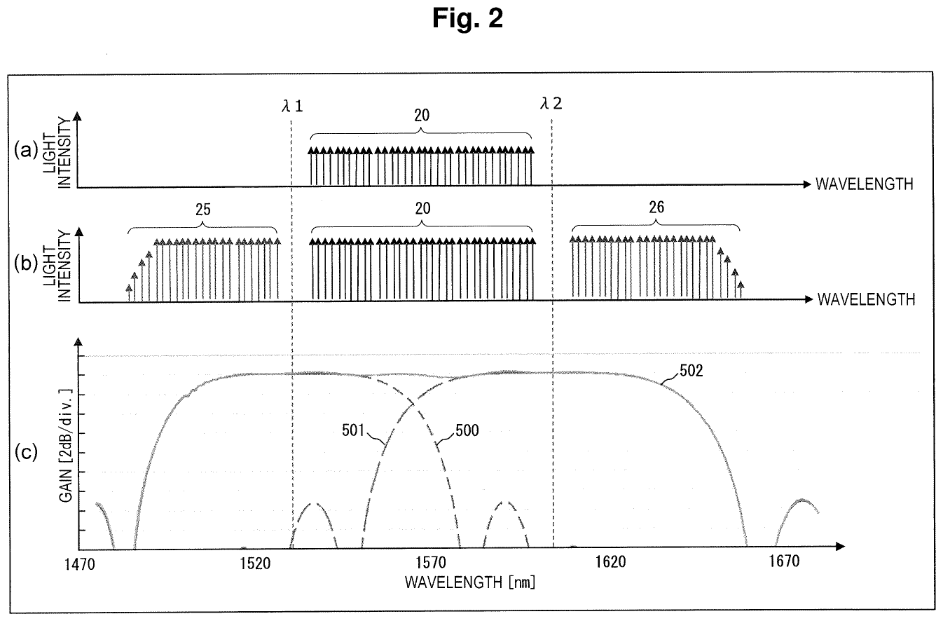

The operation of the parametric amplification in the PPLN waveguide 71 will be described below with reference to FIG. 2. In the present embodiment, the phase matching wavelength λ1 of the PPLN waveguides 61 and 71 is set to 1530 nm, the phase matching wavelength λ2 is set to 1602 nm, and the waveguide length is set to 40 mm. As illustrated in (a) of FIG. 2, it is assumed that wavelengths λsi (i=1, 2, 3, . . . ) of the signal light group 20 are densely arranged in a region from 1530 nm to 1602 nm.

The rays of second harmonic light 23 and 24 generated from the rays of fundamental wave light 21 and 22 having the wavelengths λ1 and λ2 are incident on the PPLN waveguide 71 as the excitation light. Assuming that a 3 dB band centered on the wavelength λ1 and a 3 dB band centered on the wavelength λ2 are amplification bands of the PPLN waveguide 71, each 3 dB band is a band of about 70 nm.

The short-wavelength component of the signal light group 20 is amplified by using the second harmonic light 23 having the wavelength λ1/2=765 nm as the excitation light. The long-wavelength component of the signal light group 20 is amplified by using the second harmonic light 24 having the wavelength λ2/2=801 nm as the excitation light. The phase matching wavelengths λ1 and λ2 are set in a combined band in which the gain of the entire amplified signal light group is equal. In (c) of FIG. 2, the reference sign 500 denotes the gain of the amplified signal light on the short wavelength side, and the reference sign 501 denotes the gain of the amplified signal light on the long wavelength side.

In the present embodiment, the two rays of second harmonic light generated from the two independent laser light sources 1 and 2 are used as the rays of excitation light, but, in the parametric amplification, the signal light is amplified while phase information is maintained. Therefore, the gain band of the signal light is obtained as superposition of the amplification bands of the two rays of second harmonic light. In (c) of FIG. 2, the reference sign 502 denotes the gain of the entire amplified signal light group.

What is important here is that wavelength conversion light generated with the parametric amplification by the PPLN waveguide 71 is generated outside the band of the signal light. In (b) of FIG. 2, the reference sign 25 denotes wavelength conversion light generated with respect to the signal light on the short wavelength side, and the reference sign 26 denotes wavelength conversion light generated with respect to the signal light on the long wavelength side.

When a secondary non-linear optical element having a phase matching wavelength in the band of signal light is used as in the configuration in the related art, the wavelength conversion light is generated within the band of signal light. Therefore, it is necessary to separate the signal light into a short wavelength side and a long wavelength side in advance in order to avoid interference.

On the other hand, in the present embodiment, it is not necessary to separate the signal light. Therefore, the number of secondary non-linear optical elements that perform parametric amplification may be one, and it is possible to reduce the number of components. In addition, in the present embodiment, since a wavelength demultiplexer that separates the signal light before amplification is not required, an excessive loss due to the wavelength demultiplexer does not occur, and it is possible to suppress degradation of the noise figure of the optical parametric amplifier.

In the optical parametric amplifier in the present embodiment, a flat gain can be obtained for a signal light group in a wavelength range of about 70 nm, and an unnecessary wavelength conversion light component after the parametric amplification can be removed by using the bandpass filter 8. As a result, in the present embodiment, it is possible to realize broadband amplification of about twice the band of the EDFA in the related art, with a simple configuration.

As described above, in the present embodiment, the optical parametric amplifier is configured by using the PPLN waveguides 61 and 71 having the two phase matching wavelengths λ1 and λ2 at both ends of the signal optical band. According to the present embodiment, the wavelength demultiplexer is not required as compared with the optical parametric amplifier in the related art. Thus, it is possible to not only reduce the number of components and but also suppress the excessive loss, and thus it is possible to perform amplification with a noise figure inherent in the optical parametric amplifier, and to perform broadband and low-noise optical amplification.

Note that an object of embodiments of the present invention is to realize parametric amplification of signal light with a simple configuration and low noise, and is not intended to use the wavelength conversion light as the target.

In the present embodiment, the phase matching wavelengths λ1 and λ2 are set to 1530 nm and 1602 nm, respectively, but the present invention is not limited to the wavelengths. Any phase matching wavelengths λ1 and λ2 can be set. Further, in the present embodiment, the fundamental wave light having the same wavelength as the phase matching wavelengths λ1 and λ2 is generated by the laser light sources 1 and 2, but the wavelength of the fundamental wave light may not coincide with the phase matching wavelengths λ1 and λ2 and may be in the vicinity of the phase matching wavelengths λ1 and λ2. That is, the wavelength of the second harmonic excitation light may not coincide with λ1/2 and λ2/2, and may be in the vicinity of λ1/2 and λ2/2.

In addition, in the present embodiment, the two rays of fundamental wave light 21 and 22 are multiplexed, and then the two rays of second harmonic light 23 and 24 are generated by using the PPLN waveguide 61 having the two phase matching wavelengths λ1 and λ2, but the present invention is not limited to such a configuration.

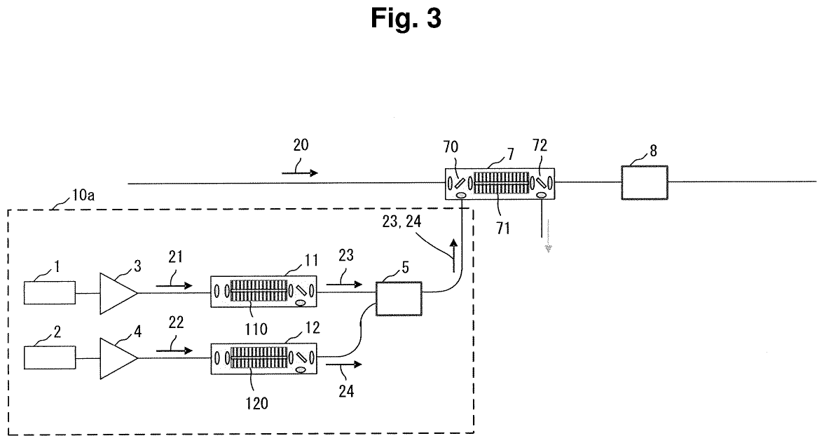

For example, as illustrated in FIG. 3, a configuration in which two secondary non-linear optical elements 11 and 12 having different phase matching wavelengths are prepared, and the rays of second harmonic light 23 and 24 output from the secondary non-linear optical elements 11 and 12 are multiplexed by the multiplexer 5 may be made. The secondary non-linear optical elements 11 and 12 include PPLN waveguides 110 and 120, respectively. The phase matching wavelength of the PPLN waveguide 110 (second optical waveguide) is λ1, and the phase matching wavelength of the PPLN waveguide 120 (third optical waveguide) is λ2. In this case, the laser light sources 1 and 2, the EDFAs 3 and 4, the secondary non-linear optical elements 11 and 12, and the multiplexer 5 constitute an excitation light generation unit 10a.

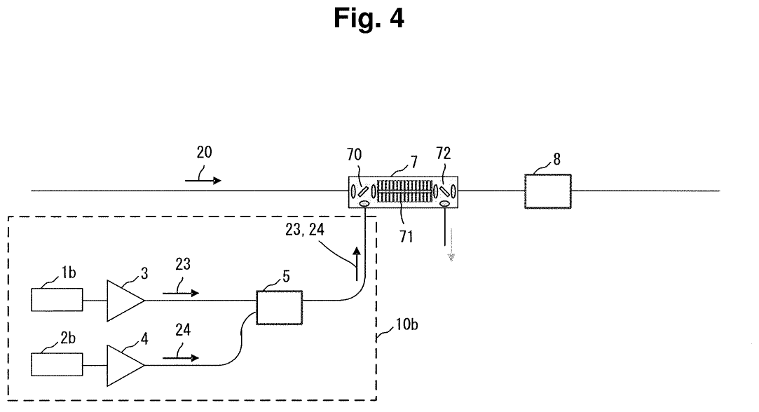

As illustrated in FIG. 4, a laser light source 1b that generates second harmonic light 23 having a wavelength in the vicinity of λ1/2 and laser light source 2b that generates second harmonic light 24 having a wavelength in the vicinity of λ2/2 may be used without using the PPLN waveguide 61, 110, and 120. In this case, the laser light sources 1b and 2b, the EDFAs 3 and 4, and the multiplexer 5 constitute an excitation light generation unit 10b.

### Second Embodiment

Next, a second embodiment of the present invention will be described. In the first embodiment, the two rays of second harmonic light generated from the fundamental wave light having the wavelengths λ1 and λ2 are input as the excitation light to the PPLN waveguide having two phase matching wavelengths λ1 and λ2 outside the wavelength range of the signal light, thereby realizing broadband optical parametric amplification. On the other hand, the present embodiment is configured to realize a broader band.

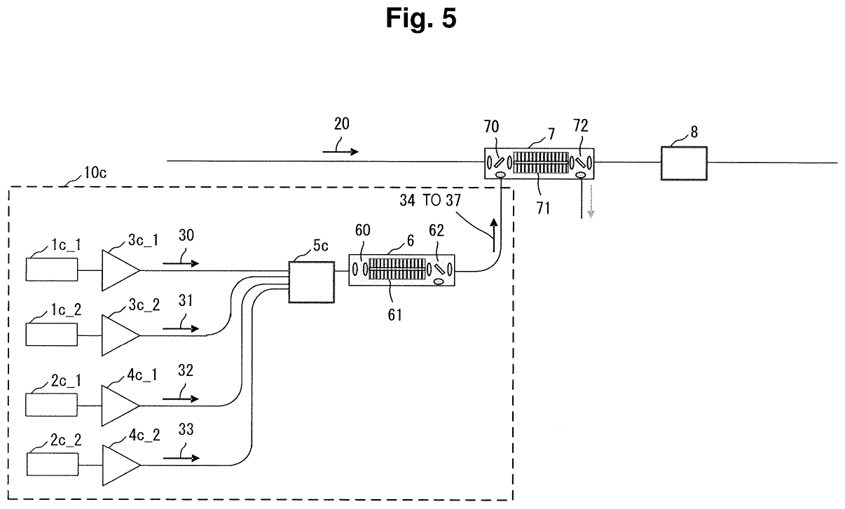

FIG. 5 is a block diagram illustrating a configuration of an optical parametric amplifier according to the present embodiment. The optical parametric amplifier in the present embodiment includes laser light sources 1c_1 and 1c_2 that generate fundamental wave light having a wavelength in the vicinity of the phase matching wavelength λ1, laser light sources 2c_1 and 2c_2 that generate fundamental wave light having a wavelength in the vicinity of the phase matching wavelength λ2, EDFAs 3c_1, 3c_2, 4c_1, and 4c_2 that amplify rays of the fundamental wave light from the laser light sources 1c_1, 1c_2, 2c_1, and 2c_2, a multiplexer 5c that multiplexes the rays of fundamental light amplified by the EDFAs 3c_1, 3c_2, 4c_1, and 4c_2, secondary non-linear optical elements 6 and 7, and a bandpass filter 8. The laser light sources 1 and 2, the EDFAs 3 and 4, the multiplexer 5, and the secondary non-linear optical element 6 constitute an excitation light generation unit 10c.

In the present embodiment, as in the first embodiment, two PPLN waveguides 61 and 71 having two phase matching wavelengths λ1 and λ2 are used. It is assumed that the phase matching wavelengths λ1 and λ2 are wavelengths at both ends of the band of signal light to be amplified. The PPLN waveguides 61 and 71 have a multi-stage periodic polarization inversion structure having two polarization inversion periods Λλ1 and Λλ2. The polarization inversion periods Λλ1 and Λλ2 satisfy the relationships of Expressions (2) and (3).

In the present embodiment, four rays of second harmonic light are used as excitation light. Thus, the fundamental wave light is generated by using four laser light sources 1c_1, 1c_2, 2c_1, and 2c_2. The EDFAs 3c_1, 3c_2, 4c_1, and 4c_2 amplify the fundamental wave light from the laser light sources 1c_1, 1c_2, 2c_1, and 2c_2 in order to obtain enough power to obtain a non-linear optical effect. The multiplexer 5c multiplexes the rays of fundamental wave light 30 to 33 amplified by the EDFAs 3c_1, 3c_2, 4c_1, and 4c_2.

The PPLN waveguide 61 having the phase matching wavelengths λ1 and λ2 generates second harmonic light from the rays of fundamental wave light 30 to 33, respectively. As a result, in the present embodiment, the rays of second harmonic light 34 to 37 having four wavelengths are generated. In the present embodiment, the laser light source 1c_1 generates fundamental wave light having a wavelength λ1_1 equal to the phase matching wavelength λ1, and the laser light source 1c_2 generates fundamental wave light having a wavelength λ1_2 subjected to slightly detuning from the phase matching wavelength λ1 toward the short wavelength side. In addition, the laser light source 2c_1 generates fundamental wave light having a wavelength λ2_1 equal to the phase matching wavelength λ2, and the laser light source 2c_2 generates fundamental wave light having a wavelength λ2_2 subjected to slightly detuning from the phase matching wavelength λ2 toward the short wavelength side.

The PPLN waveguide 71 having the phase matching wavelengths λ1 and 2 performs parametric amplification of the signal light group 20 by using the rays of second harmonic light 34 to 37 output from the PPLN waveguide 61 as excitation light.

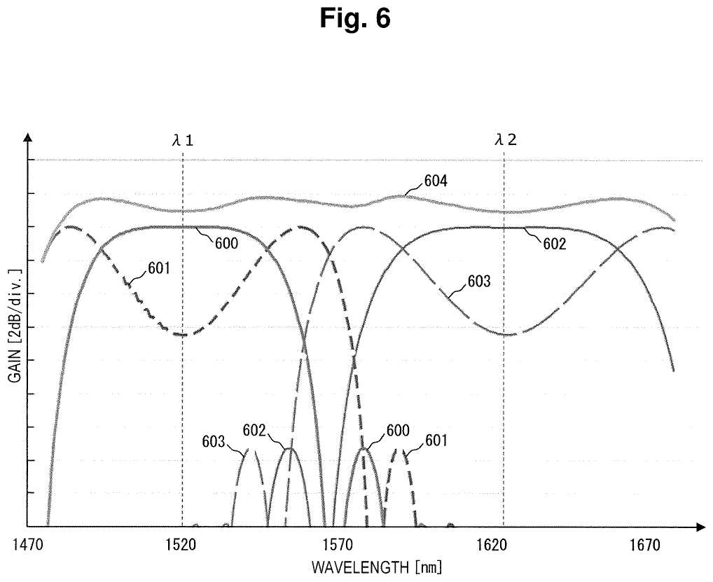

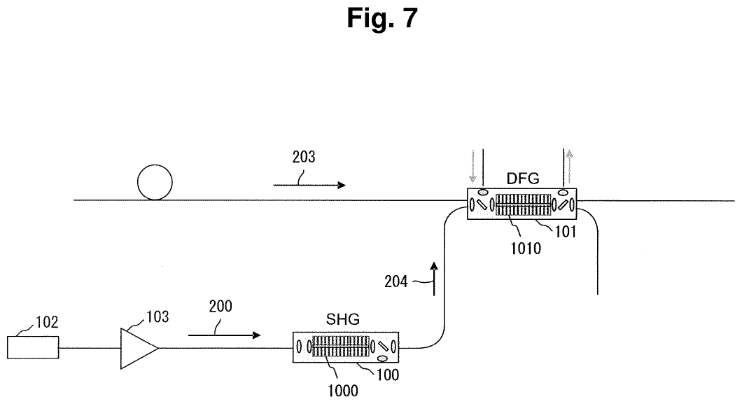

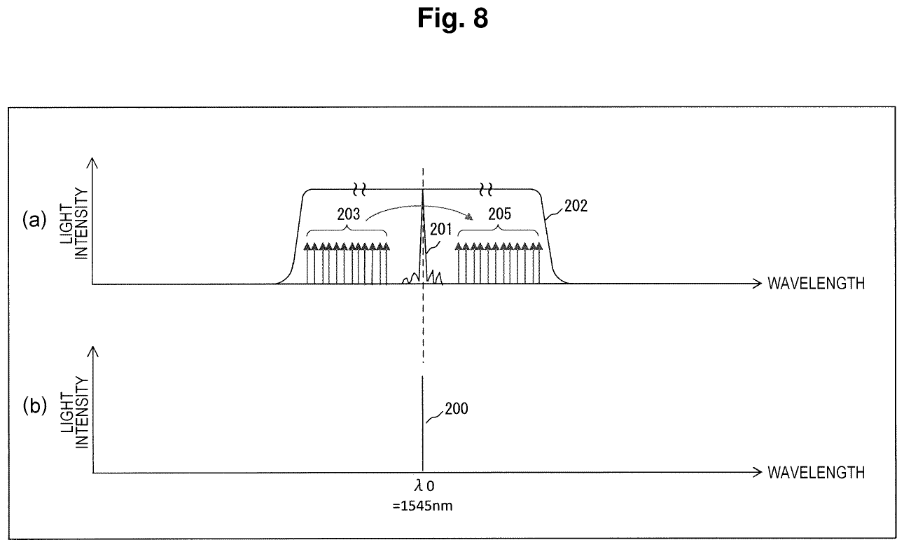

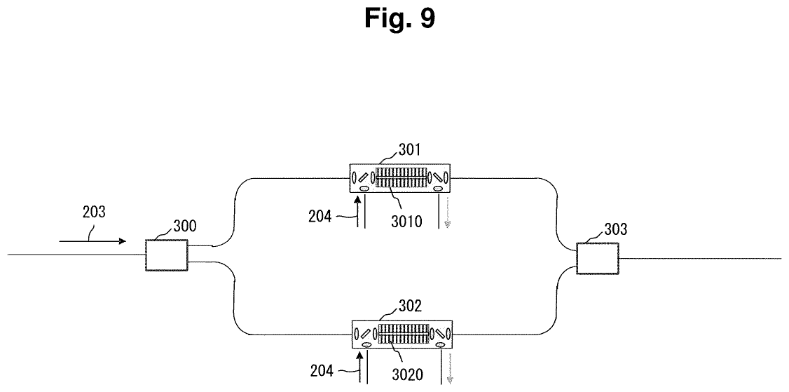

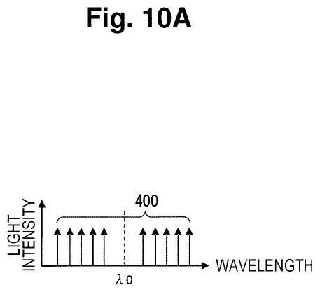

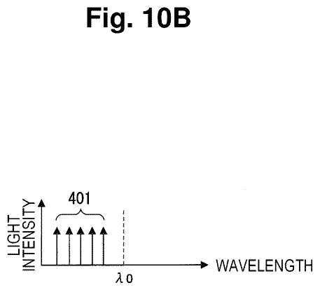

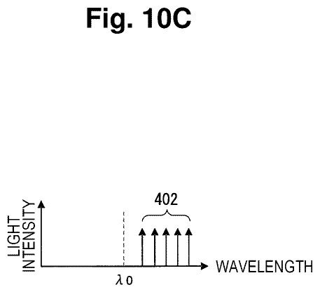

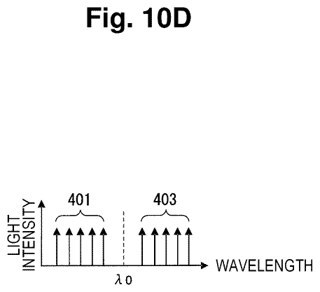

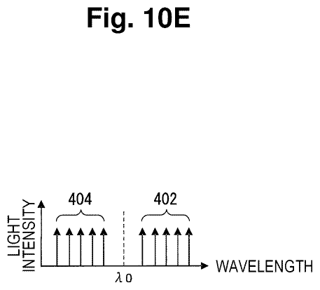

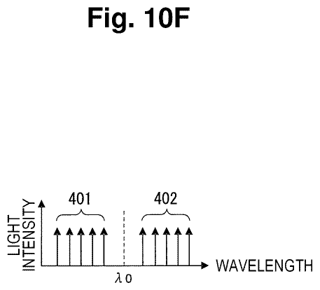

FIG. 6 illustrates an amplification band in the configuration of the present embodiment. In the present embodiment, the phase matching wavelength λ1 of the PPLN waveguides 61 and 71 is set to 1520 nm, the phase matching wavelength λ2 is set to 1625 nm. The wavelength λ1_1 (=λ1) of the fundamental wave light generated by the laser light source 1c_1 is set to 1520 nm, and the wavelength λ1_2 of the fundamental wave light generated by the laser light source 1c_2 is set to 1519.78 nm. The wavelength λ2_1 (=λ2) of the fundamental wave light generated by the laser light source 2c_1 is set to 1625 nm, and the wavelength λ2_2 of the fundamental wave light generated by the laser light source 2c_2 is set to 1624.78 nm. As the PPLN waveguide 61, a PPLN waveguide that has a length of 20 mm and has a band for the second harmonic wave having a wavelength of 0.4 nm or more was used, and the four rays of fundamental wave light were collectively converted into the second harmonic light.

The short-wavelength component of the signal light group 20 is amplified by using the second harmonic light that has a wavelength λ1_1/2 and is generated from the fundamental wave light having the wavelength λ1_1 (=λ1) as the excitation light. The amplification band of the PPLN waveguide 71 in this case has a width of about 60 nm in a 3 dB band centered on the phase matching wavelength λ1 as denoted by the reference sign 600 in FIG. 6, and is a flat band centered on the wavelength λ1.

Further, the short-wavelength component of the signal light group 20 is amplified by using the second harmonic light that has a wavelength λ1_2/2 and is generated from the fundamental wave light having the wavelength λ1_2 as the excitation light. In the amplification band of the PPLN waveguide 71 in this case, although the gain in the vicinity of the phase matching wavelength λ1 decreases as denoted by the reference sign 601 in FIG. 6, the gain can be obtained up to a broader band than the case where the second harmonic light having the wavelength λ1_1/2 is used as the excitation light.

The long-wavelength component of the signal light group 20 is amplified by using the second harmonic light that has a wavelength λ2_1/2 and is generated from the fundamental wave light having the wavelength λ2_1 (=λ2) as the excitation light. The amplification band of the PPLN waveguide 71 in this case has a width of about 60 nm in a 3 dB band centered on the phase matching wavelength λ2 as denoted by the reference sign 602 in FIG. 6, and is a flat band centered on the wavelength λ2.

Further, the long-wavelength component of the signal light group 20 is amplified by using the second harmonic light that has a wavelength λ2_2/2 and is generated from the fundamental wave light having the wavelength λ2_2 as the excitation light. In the amplification band of the PPLN waveguide 71 in this case, although the gain in the vicinity of the phase matching wavelength λ2 decreases as denoted by the reference sign 603 in FIG. 6, the gain can be obtained up to a broader band than the case where the second harmonic light having the wavelength λ2_1/2 is used as the excitation light.

The present embodiment aims to make a composite band of four rays of second harmonic excitation light have a broadband and flat characteristics by using the characteristics of the amplification band described above. In FIG. 6, the reference sign 604 denotes the gain of the entire amplified signal light group. As illustrated in FIG. 6, in the present embodiment, a broadband amplification band having flatness within 1 dB is realized in a band exceeding a width of 100 nm from a wavelength of 1520 nm to 1625 nm.

When parametric amplification is performed by using a plurality of rays of second harmonic excitation light, generally, the signal light is wavelength-converted at different wavelengths of the rays of second harmonic excitation light. Thus, even when the same signal light is converted, the wavelength of conversion light is different for each of the rays of second harmonic excitation light. Therefore, the rays of conversion light having the shifted wavelengths overlap each other, and this causes interference to destroy the original signal information. However, since the present embodiment is intended only for the parametric amplification of the signal light, there is no problem as described above even though a plurality of different rays of second harmonic excitation light are used, and it is possible to perform the optical amplification while maintaining the phase information of the signal.

As described above, in the present embodiment, by using the PPLN waveguides 61 and 71 having the two phase matching wavelengths λ1 and λ2 at both ends of the signal light band and the plurality of rays of second harmonic excitation light, it is possible to realize broadband optical amplification as compared with the EDFA in the related art. According to the present embodiment, the wavelength demultiplexer is not required as compared with the optical parametric amplifier in the related art. Thus, it is possible to not only reduce the number of components and but also suppress the excessive loss, and thus it is possible to perform amplification with a noise figure inherent in the optical parametric amplifier, and to perform broadband and low-noise optical amplification.

In the present embodiment, four rays of fundamental wave light are used by providing the plurality of laser light sources 1c_1 and 1c_2 that generate the fundamental wave light having the wavelength in the vicinity of λ1 and the plurality of laser light sources 2c_1 and 2c_2 that generate the fundamental wave light having the wavelength in the vicinity of λ2. A larger number of light sources may be used, and it is not necessary to align the number of light sources on the short wavelength side and the long wavelength side. Further, in the present embodiment, an independent light source is used, but a plurality of rays of fundamental wave light may be generated by using an optical modulator or the like.

In addition, the excitation light generation unit having the configuration illustrated in FIG. 3 may be applied to the present embodiment. In this case, a plurality of laser light sources 1 that generate fundamental wave light having a wavelength in the vicinity of λ1, a plurality of laser light sources 2 that generate fundamental wave light having a wavelength in the vicinity of λ2, a plurality of EDFAs 3 that amplify the fundamental wave light from the laser light sources 1, a plurality of EDFAs 4 that amplify the excitation light from the laser light sources 2, a plurality of secondary non-linear optical elements 11 that have a phase matching wavelength λ1 and generate second harmonic light from the fundamental wave light amplified by the EDFA 3, and a plurality of secondary non-linear optical elements 12 that have a phase matching wavelength λ2 and generate second harmonic light from the fundamental wave light amplified by the EDFA 4, a multiplexer 5 that multiplexes the second harmonic light generated by the secondary non-linear optical element 11 and the second harmonic light generated by the secondary non-linear optical element 12 may be provided.

In addition, the excitation light generation unit having the configuration illustrated in FIG. 4 may be applied to the present embodiment. In this case, a plurality of laser light sources 1b that generates excitation light having a wavelength in the vicinity of λ1/2, a plurality of laser light sources 2b that generates excitation light having a wavelength in the vicinity of λ2/2, a plurality of EDFAs 3 that amplify the excitation light from the laser light sources 1b, and a plurality of EDFAs 4 that amplify the excitation light from the laser light sources 2b may be provided, and the rays of excitation light amplified by the EDFAs 3 and 4 may be multiplexed by the multiplexer 5.

Further, in the present embodiment, the phase matching wavelengths λ1 and λ2 are set to 1520 nm and 1625 nm, respectively, but the present invention is not limited to the wavelengths. Any phase matching wavelengths λ1 and λ2 can be set.

In addition, in the first and second embodiments, LiNbO3 is used as the non-linear optical crystal constituting the optical waveguide of the secondary non-linear optical element, but the present invention is not limited thereto. LiTaO3 or LiNb(x)Ta(1−x)O3 (0≤x≤1) may be used. In addition, non-linear optical crystal in which at least one element of Mg, Zn, Sc, and In is doped to LiNbO3, LiTaO3, or LiNb(x)Ta(1−x)O3 may be used.

Some or all of the above embodiments may be described as the following supplementary notes, but are not limited to the following.

(Supplementary note 1) An optical parametric amplifier including: a first optical waveguide having two phase matching wavelengths λ1 and λ2 (λ1<λ2), the first optical waveguide configured to perform parametric amplification of a signal light group; and an excitation light generation unit configured to generate excitation light to be input to the first optical waveguide, in which the phase matching wavelengths λ1 and λ2 are set to satisfy a relationship of λ1<λsi<λ2 with respect to a wavelength λsi (i=1, 2, 3, . . . ) of the signal light group, the excitation light generation unit generates excitation light having one or a plurality of wavelengths in the vicinity of λ1/2 and excitation light having one or a plurality of wavelengths in the vicinity of λ2/2 and inputs the generated rays of excitation light to the first optical waveguide, the first optical waveguide is made of non-linear optical crystal having a periodic polarization inversion structure having two polarization inversion periods Λλ1 and Λλ2, and when a refractive index of light having a wavelength λ1/2 in the first optical waveguide is represented by nλ1/2, a refractive index of light having a wavelength λ2/2 is represented by nλ2/2, a refractive index of light having a wavelength λ1 is set as nλ1, and a refractive index of light having a wavelength λ2 is represented by nλ2, the polarization inversion periods Λλ1 and Λλ2 satisfy relationships of nλ1/2/(λ1/2)−2nλ1/λ1=1/Λλ1, and nλ2/2/(λ2/2)−2nλ2/λ2=1/Λλ2.

(Supplementary note 2) The optical parametric amplifier described in Supplementary note 1, in which the excitation light generation unit includes one or a plurality of first light sources configured to generate fundamental wave light having one or a plurality of wavelengths in the vicinity of the phase matching wavelength λ1, one or a plurality of second light sources configured to generate fundamental wave light having one or a plurality of wavelengths in the vicinity of the phase matching wavelength λ2, a multiplexer configured to multiplex the fundamental wave light generated by the first light source and the fundamental wave light generated by the second light source, and a second optical waveguide that has the phase matching wavelengths λ1 and λ2 and is configured to generate second harmonic light from the fundamental wave light multiplexed by the multiplexer, the second optical waveguide is made of non-linear optical crystal having a periodic polarization inversion structure having the polarization inversion periods Λλ1 and Λλ2, and the second harmonic light generated by the second optical waveguide is input to the first optical waveguide as the excitation light.

(Supplementary note 3) The optical parametric amplifier described in Supplementary note 1, in which the excitation light generation unit includes one or a plurality of first light sources configured to generate the excitation light having the one or the plurality of wavelengths in the vicinity of λ1/2, one or a plurality of second light sources configured to generate the excitation light having the one or the plurality of wavelengths in the vicinity of λ2/2, and a multiplexer configured to multiplex the excitation light generated by the first light source and the excitation light generated by the second light source, and the excitation light multiplexed by the multiplexer is input to the first optical waveguide.

(Supplementary note 4) The optical parametric amplifier described in Supplementary note 1, in which the excitation light generation unit includes one or a plurality of first light sources configured to generate fundamental wave light having one or a plurality of wavelengths in the vicinity of the phase matching wavelength λ1, one or a plurality of second light sources configured to generate fundamental wave light having one or a plurality of wavelengths in the vicinity of the phase matching wavelength λ2, one or a plurality of second optical waveguides that have the phase matching wavelength λ1 and are configured to generate second harmonic light from the fundamental wave light generated by the one or the plurality of first light sources, one or a plurality of third optical waveguides that have the phase matching wavelength λ2 and are configured to generate second harmonic light from the fundamental wave light generated by the one or the plurality of second light sources, and a multiplexer configured to multiplex the second harmonic light generated by the second optical waveguide and the second harmonic light generated by the third optical waveguide, the second optical waveguide is made of non-linear optical crystal having a periodic polarization inversion structure having the polarization inversion period Λλ1, the third optical waveguide is made of non-linear optical crystal having a periodic polarization inversion structure having the polarization inversion period Λλ2, and the second harmonic light multiplexed by the multiplexer is input to the first optical waveguide as excitation light.

### INDUSTRIAL APPLICABILITY

The embodiments of the present invention can be applied to a technique for amplifying an optical signal.

### REFERENCE SIGNS LIST

1, 1b, 1c_1, 1c_2, 2, 2b, 2c_1, 2c_2 Laser light source
3, 3c_1, 3c_2, 4, 4c_1, 4c_2 EDFA
5, 5c Multiplexer
6, 7, 11, 12 Secondary non-linear optical element
8 Bandpass filter
10, 10a to 10c Excitation light generation unit
60, 62, 70, 72 Spatial optical system
61, 71, 110, 120PPLN waveguide

1-5. (canceled)

6. An optical parametric amplifier comprising:
a first optical waveguide having two phase matching wavelengths λ1 and λ2 (λ1<λ2), the first optical waveguide configured to perform parametric amplification of a signal light group; and
an excitation light generator configured to generate excitation light to be input to the first optical waveguide,
wherein the phase matching wavelengths λ1 and λ2 are set to satisfy a relationship of λ1<λsi<λ2 with respect to a wavelength λsi (i=1, 2, 3, . . . ) of the signal light group,
the excitation light generator configured to generate excitation light having a wavelength in the vicinity of λ1/2 and excitation light having a wavelength in the vicinity of λ2/2 and inputs the generated rays of excitation light to the first optical waveguide, and
the first optical waveguide comprises non-linear optical crystal having a periodic polarization inversion structure having two polarization inversion periods Λλ1 and Λλ2, and when a refractive index of light having a wavelength λ1/2 in the first optical waveguide is represented by nλ1/2, a refractive index of light having a wavelength λ2/2 is represented by nλ2/2, a refractive index of light having a wavelength λ1 is represented by nλ1, and a refractive index of light having a wavelength λ2 is represented by nλ2, the polarization inversion periods Λλ1 and Λλ2 satisfy relationships of nλ1/2/(λ1/2)−2nλ1/λ1=1/Λλ1, and nλ2/2/(λ2/2)−2nλ2/λ2=1/Λλ2.

7. The optical parametric amplifier according to claim 6, wherein
the excitation light generator includes
a first light source configured to generate fundamental wave light having a wavelength in the vicinity of the phase matching wavelength λ1,
a second light source configured to generate fundamental wave light having a wavelength in the vicinity of the phase matching wavelength λ2,
a multiplexer configured to multiplex the fundamental wave light generated by the first light source and the fundamental wave light generated by the second light source, and
a second optical waveguide that has the phase matching wavelengths λ1 and λ2 and is configured to generate second harmonic light from the fundamental wave light multiplexed by the multiplexer,
the second optical waveguide comprises non-linear optical crystal having a periodic polarization inversion structure having the polarization inversion periods Λλ1 and Λλ2, and the second harmonic light generated by the second optical waveguide is input to the first optical waveguide as the excitation light.

8. The optical parametric amplifier according to claim 6, wherein
the excitation light generator includes
a first light source configured to generate the excitation light having the one or the plurality of wavelengths in the vicinity of λ1/2,
a second light source configured to generate the excitation light having the one or the plurality of wavelengths in the vicinity of λ2/2, and
a multiplexer configured to multiplex the excitation light generated by the first light source and the excitation light generated by the second light source, and
the excitation light multiplexed by the multiplexer is input to the first optical waveguide.

9. The optical parametric amplifier according to claim 6, wherein
the excitation light generator includes
a first light source configured to generate fundamental wave light having a wavelength in the vicinity of the phase matching wavelength λ1,
a second light source configured to generate fundamental wave light having a wavelength in the vicinity of the phase matching wavelength λ2,
a second optical waveguide having the phase matching wavelength λ1 and configured to generate second harmonic light from the fundamental wave light generated by the first light source,
a third optical waveguide having the phase matching wavelength λ2 and configured to generate second harmonic light from the fundamental wave light generated by the one or the plurality of second light sources, and
a multiplexer configured to multiplex the second harmonic light generated by the second optical waveguide and the second harmonic light generated by the third optical waveguide,
the second optical waveguide comprises non-linear optical crystal having a periodic polarization inversion structure having the polarization inversion period Λλ1,
the third optical waveguide comprises non-linear optical crystal having a periodic polarization inversion structure having the polarization inversion period Λλ2, and
the second harmonic light multiplexed by the multiplexer is input to the first optical waveguide as excitation light.

10. The optical parametric amplifier according to claim 6, wherein
the non-linear optical crystal comprises LiNbO3, LiTaO3, or LiNb(x)Ta(1−x)O3 (0≤x≤1).

11. The optical parametric amplifier according to claim 10, wherein
the non-linear optical crystal comprises a material obtained by doping at least one selected from the group consisting of Mg, Zn, Sc, or In as an additive to LiNbO3, LiTaO3, or LiNb(x)Ta(1−x)O3 (0≤x≤1).

12. The optical parametric amplifier according to claim 7, wherein
the non-linear optical crystal comprises LiNbO3, LiTaO3, or LiNb(x)Ta(1−x)O3 (0≤x≤1).

13. The optical parametric amplifier according to claim 12, wherein
the non-linear optical crystal comprises a material obtained by doping at least one selected from the group consisting of Mg, Zn, Sc, or In as an additive to LiNbO3, LiTaO3, or LiNb(x)Ta(1−x)O3 (0≤x≤1).

14. The optical parametric amplifier according to claim 8, wherein
the non-linear optical crystal comprises LiNbO3, LiTaO3, or LiNb(x)Ta(1−x)O3 (0≤x≤1).

15. The optical parametric amplifier according to claim 14, wherein
the non-linear optical crystal comprises a material obtained by doping at least one selected from the group consisting of Mg, Zn, Sc, or In as an additive to LiNbO3, LiTaO3, or LiNb(x)Ta(1−x)O3 (0≤x≤1).

16. The optical parametric amplifier according to claim 9, wherein
the non-linear optical crystal comprises LiNbO3, LiTaO3, or LiNb(x)Ta(1−x)O3 (0≤x≤1).

17. The optical parametric amplifier according to claim 16, wherein
the non-linear optical crystal comprises a material obtained by doping at least one selected from the group consisting of Mg, Zn, Sc, or In as an additive to LiNbO3, LiTaO3, or LiNb(x)Ta(1−x)O3 (0≤x≤1).

18. The optical parametric amplifier according to claim 12, wherein
the non-linear optical crystal comprises LiNbO3, LiTaO3, or LiNb(x)Ta(1−x)O3 (0≤x≤1).

19. An optical parametric amplification method comprising:
providing a first optical waveguide having two phase matching wavelengths λ1 and λ2 (λ1<λ2), the first optical waveguide configured to perform parametric amplification of a signal light group;
generating excitation light having a wavelength in the vicinity of λ1/2 and excitation light having a wavelength in the vicinity of λ2/2;
inputting the generated rays of excitation light to the first optical waveguide; and
performing parametric amplification of the signal light group using the first optical waveguide,
wherein the phase matching wavelengths λ1 and λ2 are set to satisfy a relationship of λ1<λsi<λ2 with respect to a wavelength λsi (i=1, 2, 3, . . . ) of the signal light group,
the first optical waveguide comprises non-linear optical crystal having a periodic polarization inversion structure having two polarization inversion periods Λλ1 and Λλ2, and
when a refractive index of light having a wavelength λ1/2 in the first optical waveguide is represented by nλ1/2, a refractive index of light having a wavelength λ2/2 is represented by nλ2/2, a refractive index of light having a wavelength λ1 is represented by nλ1, and a refractive index of light having a wavelength λ2 is represented by nλ2, the polarization inversion periods Λλ1 and Λλ2 satisfy relationships of nλ1/2/(λ1/2)−2nλ1/λ1=1/Λλ1, and nλ2/2/(λ2/2)−2nλ2/λ2=1/Λλ2.

20. The optical parametric amplification method according to claim 19, wherein generating the excitation light comprises:
generating fundamental wave light having a wavelength in the vicinity of the phase matching wavelength λ1 using a first light source;
generating fundamental wave light having a wavelength in the vicinity of the phase matching wavelength λ2 using a second light source;
multiplexing the fundamental wave light generated by the first light source and the fundamental wave light generated by the second light source; and
generating second harmonic light from the multiplexed fundamental wave light using a second optical waveguide that has the phase matching wavelengths λ1 and λ2,
wherein the second optical waveguide comprises non-linear optical crystal having a periodic polarization inversion structure having the polarization inversion periods Λλ1 and Λλ2, and
the second harmonic light generated by the second optical waveguide is input to the first optical waveguide as the excitation light.

21. The optical parametric amplification method according to claim 19, wherein the non-linear optical crystal comprises LiNbO3, LiTaO3, or LiNb(x)Ta(1−x)O3 (0≤x≤1).

22. The optical parametric amplification method according to claim 21, wherein the non-linear optical crystal comprises a material obtained by doping at least one selected from the group consisting of Mg, Zn, Sc, or In as an additive to LiNbO3, LiTaO3, or LiNb(x)Ta(1−x)O3 (0≤x≤1).
